(19) United States
(12) Patent Application Publication
(10) Pub. No.: US 2026/0367979 A1
(43) Pub. Date: Nov. 19, 2026

(54) Hardware Assisted Dynamic Scheduling of a Single Multiprotocol Radio

(71) Applicant: Silicon Laboratories Inc., Austin, TX (US)

(72) Inventors: Richard Redemske, Quincy, MA (US); Aditya Sarda, Austin, TX (US); Hasan Ali Stationwala, Hyderabad (IN); Atul Suresh Joshi, Pune (IN); Logan Lucas, Austin, TX (US); Bryan Murawski, Belmont, MA (US)

(21) Appl. No.: 19/212,414

(22) Filed: May 19, 2025

(51) Int. Cl. G06F 9/50

(52) U.S. Cl. CPC G06F 9/5027

(57) ABSTRACT

A hardware scheduler that operates with a software scheduler to execute a plurality of tasks from different network protocols is disclosed. The hardware scheduler is used to determine the appropriate time to generate an interrupt to the software scheduler for each task. In response to an interrupt, the software scheduler determines what action to take with respect to the task. The software scheduler may execute the task, cancel the task or defer the task until a later time. This decision is then relayed to the hardware scheduler. In the case of a deferred task, the hardware scheduler monitors various conditions to determine when to generate another interrupt for the deferred task.

### FIELD

This disclosure describes systems and methods allowing the operation of multiple network protocols using a single radio using a combination of a software scheduler and a hardware scheduler.

### BACKGROUND

The proliferation of networks has led to challenges for those attempting to design devices that utilize multiple network protocols. For example, Wi-Fi, ZigBee, Thread, Bluetooth and Bluetooth Low Energy are all prevalent network protocols. In many situations, more than one type of network protocol is supported by a device. As an example, a mobile phone may have a Wi-Fi interface, a Bluetooth interface, and a cellular interface. Further, most computing devices, includes tablets and laptops support at least two different network protocols.

Because of the need to support multiple network protocols with a single device, there is a desire to use a single radio to operate all of these wireless protocols. This minimizes cost, real estate and power.

However, each wireless protocol has its own unique timing requirements. Certain protocols allow a device to fail to respond for long periods of time. For example, ZigBee® utilizes the concept of a sleepy end device, where a device may be in a low power state for several minutes. During this time, it does not respond to any attempts to access it. On the other hand, other protocols have a connection timeout period, wherein if the device does not receive a packet from the sender within that connection timeout period, the connection fails.

Because of these differences in protocol, creating a scheduler that can handle multiple wireless protocols is challenging. A software scheduler may be used to implement all of the logic to manage these different requirements. However, the logic used by a software scheduler to manage these multiple protocols may be time and processor intensive. Therefore, it would be beneficial if there were a hardware scheduler that could receive tasks, such as transmit and receive requests, from different network protocol software stacks, and present these tasks in an optimal manner to a software scheduler to offload some of this processing.

### SUMMARY

A hardware scheduler that operates with a software scheduler to execute a plurality of tasks from different network protocols is disclosed. The hardware scheduler is used to determine the appropriate time to generate an interrupt to the software scheduler for each task. In response to an interrupt, the software scheduler determines what action to take with respect to the task. The software scheduler may execute the task, cancel the task or defer the task until a later time. This decision is then relayed to the hardware scheduler. In the case of a deferred task, the hardware scheduler monitors various conditions to determine when to generate another interrupt for the deferred task.

According to one embodiment, a network device is disclosed. The network device comprises a network interface that comprises a radio; a processing unit; a hardware scheduler; and a memory device, in communication with the processing unit, wherein the memory device comprises: a plurality of network protocol software stacks, each responsible for managing a network protocol; and a software scheduler; wherein each network protocol software stack provides metadata about a task to the hardware scheduler; wherein the hardware scheduler uses the metadata to determine when to generate an interrupt to the software scheduler; and wherein, after receiving the interrupt, the software scheduler: selects one of the tasks; and schedules the selected task to be executed by the network interface. In some embodiments, the metadata comprises: an earliest start time, which is an earliest time that the task can begin; a latest start time, which is a latest time that the task can begin; and a priority. In certain embodiments, the metadata comprises an initialization time, which is a time required for the software scheduler to configure the network interface to perform the task. In some embodiments, if a current time is greater than an adjusted earliest start time of the task, the hardware scheduler generates the interrupt if: the network interface is idle; the network interface is executing a background task having a lower priority; or the current time is greater than an adjusted latest start time of the task. In some embodiments, each network protocol software stack comprises a queue of tasks associated with the network protocol, and the metadata is associated with the task at a head of the queue of tasks. In some embodiments, the hardware scheduler comprises a plurality of state machines, each state machine associated with one of the plurality of network protocol software stacks, wherein each state machine is provided with the metadata. In certain embodiments, each of the plurality of state machines determines when to generate the interrupt based on the metadata. In some embodiments, after receiving the interrupt, the software scheduler defers a task, and the hardware scheduler generates a second interrupt when a current time exceeds a latest adjusted start time for the deferred task. In some embodiments, after selecting the task, the software scheduler cancels another task, and the hardware scheduler returns to an inactive state awaiting new task metadata from a network protocol software stack associated with the cancelled task. In some embodiments, after the task is executed and completed, the network protocol software stack associated with the completed task provides metadata about a second task to the hardware scheduler. In some embodiments, each task has an associated conflict table and the software scheduler evaluates the conflict table before selecting the task to execute.

According to another embodiment, a method of scheduling tasks in a network device that supports multiple network protocols is disclosed. The method comprises providing a network protocol software stack for each network protocol, wherein each network protocol software stack comprises a queue of tasks to be executed by a network interface of the network device; copying, from each network protocol software stack to a hardware scheduler, metadata from one task of its respective queue of tasks; using the hardware scheduler to determine when to generate an interrupt for each task to a software scheduler; and upon receiving the interrupt from the hardware scheduler, using the software scheduler to select a task to execute and inform the network protocol software stack of the selection. In some embodiments, in response to receiving the interrupt, the software scheduler may select to execute, defer or cancel the task. In some embodiments, the metadata comprises: an earliest start time, which is an earliest time that the task can begin; a latest start time, which is a latest time that the task can begin; and a priority. In certain embodiments, the metadata comprises an initialization time, which is a time required for the software scheduler to configure the network interface to perform the task. In some embodiments, if a current time is greater than an adjusted earliest start time of the task, the hardware scheduler generates the interrupt if: the network interface is idle; the network interface is executing a background task having a lower priority; or the current time is greater than an adjusted latest start time of the task. In some embodiments, after receiving the interrupt, the software scheduler defers a task, and the hardware scheduler generates a second interrupt when a current time exceeds a latest adjusted start time for the deferred task. In some embodiments, after selecting the task, the software scheduler cancels another task, and the hardware scheduler returns to an inactive state awaiting new task metadata from a network protocol software stack associated with the cancelled task. In some embodiments, after the task is executed and completed, the network protocol software stack associated with the completed task provides metadata about a second task to the hardware scheduler. In some embodiments, each task has an associated conflict table and the software scheduler evaluates the conflict table before selecting the task to execute.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of the multi-protocol network device;

FIG. 2 illustrates the interface between the software scheduler and the network protocol software stacks;

FIG. 3 represents the information provided to the software scheduler;

FIG. 4 illustrates the interface between the software scheduler, the hardware scheduler and the network protocol software stacks; and

FIG. 5 illustrates a flowchart showing the operation of the hardware scheduler.

### DETAILED DESCRIPTION

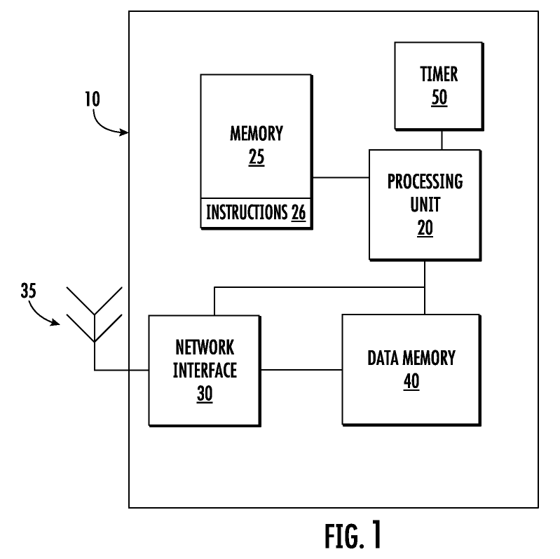

FIG. 1 shows a block diagram of a multi-protocol network device. Throughout this disclosure, the term “multi-protocol network device” is used to refer to any device that utilizes multiple network protocols. In certain embodiments, the network protocols may all operate in the same frequency spectrum, such as Wi-Fi, ZIGBEE®, Thread, Bluetooth®, and Bluetooth Low Energy (BLE). Other network protocols layered on IEEE 802.15.4 would also operate in the same frequency spectrum. It is understood that the techniques and systems described herein are applicable to any frequency spectrum. Furthermore, the present disclosure is also applicable to a radio which is capable of operating at two or more different frequency bands. Thus, the multi-protocol network device is not limited only to devices that implement multiple protocols that operate on the same frequency band. Rather, network devices that implement two or more network protocols that utilize different frequency ranges are also within the scope of the disclosure.

FIG. 1 shows a block diagram of a multi-protocol network device 10. The multi-protocol network device 10 has a processing unit 20 and an associated memory device 25. This memory device 25 contains the instructions 26, which, when executed by the processing unit 20, enable the multi-protocol network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. In all embodiments, the memory device 25 is a non-transitory storage medium. The multi-protocol network device 10 also includes a network interface 30, which is a wireless interface that includes an antenna 35. Additionally, the network interface comprises a radio, which may include the baseband processing and lower MAC level processing. The multi-protocol network device 10 may include a data memory device 40 in which data that is received by the network interface 30, and data that is to be transmitted by the network interface 30, is stored. This data memory device 40 is traditionally a volatile memory. The processing unit 20 has the ability to read and write the data memory device 40 so as to communicate with the other nodes in the networks. The multi-protocol network device 10 also includes a timer 50. Although not shown, the multi-protocol network device 10 also has a power supply, which may be a battery or a connection to a permanent power source, such as a wall outlet.

Within the multi-protocol network device 10, there are a plurality of network protocol software stacks. Each network protocol software stack is responsible for maintaining a connection to the other devices in the network that utilize that protocol. Additionally, each network protocol software stack is responsible for receiving, parsing and responding to incoming packets that are received using that protocol. Each network protocol software stack may perform all upper MAC processing. In essence, each network protocol software stack operates independently of the other network protocol software stacks. For example, each may have a defined region within the data memory device 40 where incoming and outgoing packets are disposed. These network protocol software stacks are software programs that may be stored in the memory device 25 and executed by the processing unit 20.

However, the multi-protocol network device 10 only utilizes a single network interface 30. Thus, although the network protocol software stacks operate independently of one another, they share common hardware components. In this embodiment, the network protocol software stacks share a common resource, specifically, the network interface 30 and its associated radio.

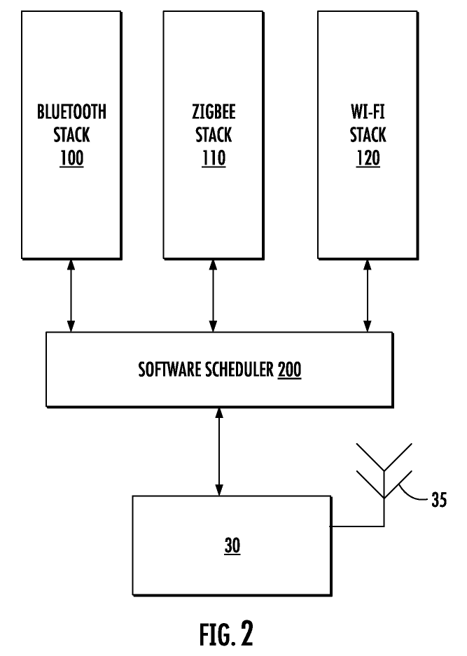

FIG. 2 illustrates the interaction between the network protocol software stacks and the network interface 30. In this figure, a Bluetooth network software stack 100, a ZigBee network software stack 110 and a Wi-Fi network software stack 120 exist within the multi-protocol network device 10. These three network protocol software stacks communicate with a software scheduler 200, which directs the actions of the network interface 30. Thus, the software scheduler 200 resides between the upper MAC (which is disposed within the network protocol software stacks) and the lower MAC (which is disposed in the network interface 30). While three network protocol software stacks are shown in FIG. 2, it is understood that the disclosure is not limited to this embodiment. Rather, the software scheduler 200 can interface with any number of network protocol software stacks.

While, in certain embodiments, a single processing unit is used to execute the code associated with the network protocol software stacks and the software scheduler 200, other embodiments are also possible. For example, the code associated with each network protocol software stack may be executed by a dedicated processing unit. Additionally, the code associated with the software scheduler 200 may be executed by a processing unit that is different than the processing unit used to execute the code for one or more of the network protocol software stacks. Thus, while the system may be as described in FIG. 1, the scheduler is not limited to operating only in single processing unit environments.

The software scheduler 200 is responsible for many functions. First, it is responsible for configuring the network interface 30 for the requested protocol. For example, before the Bluetooth network software stack 100 can transmit a packet, the radio in the network interface 30 must be configured to operate using the wireless parameters associated with the Bluetooth protocol. Similarly, if the Bluetooth network software stack 100 wishes to monitor the shared medium (i.e. the air) for incoming packets, the radio must be correctly configured. The software scheduler 200 is responsible for this configuration activity.

The software scheduler 200 is also responsible for selecting the next operation to be performed from those requested by the various network protocol software stacks. For example, the Bluetooth network software stack 100 may include a list of tasks that need to be taken. These tasks may include transmitting a message to one or more destinations, configuring the radio to listen for an expected incoming message, and others. For example, BLE is very time sensitive and the Bluetooth network software stack 100 schedules transmits at very specific times and also schedules small receive windows at times when it expects an incoming packet. The ZigBee network software stack 110 and the Wi-Fi network software stack 120 may have a similar list of tasks.

In certain embodiments, each network protocol software stack is responsible for prioritizing the tasks for that particular network protocol. In this case, the software scheduler 200 needs to select between the next task that is being requested by each network protocol software stack.

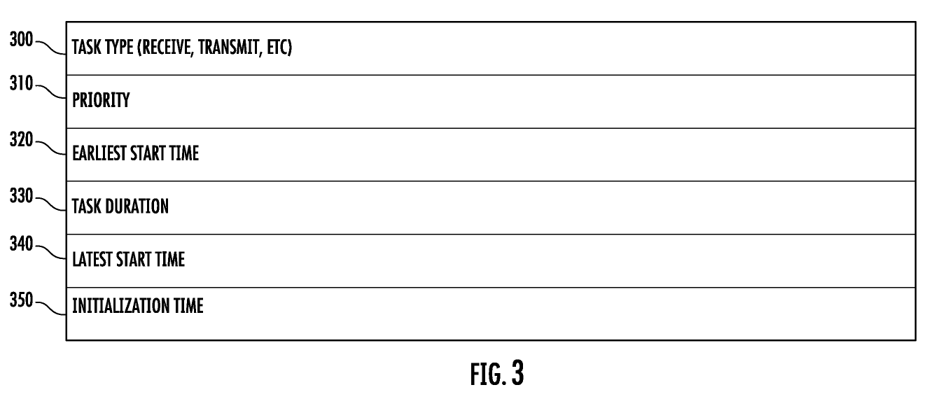

In one embodiment, each network protocol software stack is responsible for providing certain information to the software scheduler 200. FIG. 3 shows a representation of the information that may be supplied to the software scheduler 200, according to one embodiment. One piece of information is the task type 300. Task type 300 may be a transmit request, a receive request, or some other task. The priority 310 indicates the importance of the task. A higher priority indicates that the task is more important than a lower priority task. The earliest start time 320 is an indication of the earliest time that the network protocol software stack desires that the task take place. A value of 0 may be used to indicate that the task should take place at the present time. Greater values indicate that the tasks should be delayed before it takes place. The task duration 330 is an estimation of the amount of time that the requested task will take. For example, the duration of a transmit task may be estimated based on the number of bytes that are to be transmitted and the transmission rate of that network protocol. The latest start time 340 is the latest time that the task may begin. For time critical tasks, this value may be the same as the earliest start time 320. In other embodiments, the latest start time 340 may be set to a larger number, thereby allowing the software scheduler 200 more insight and flexibility in coordinating the various tasks. The initialization time 350 is an indication of how the amount of time that the network protocol software stack believes is needed to configure the radio before the task may commence.

These pieces of information may be used by the software scheduler 200 to intelligently schedule the tasks from the multiple network protocol software stacks so as to minimize the number of failed attempts.

Assume that the first task from the Bluetooth network software stack 100 has a task duration of 500 milliseconds, a priority of 4, an earliest start time of 0 and a latest start time of 300 milliseconds. Assume also that the second task from the Zigbee network software stack 110 has a task duration of 100 milliseconds, a priority of 3, a earliest start time of 0 and a latest start time of 200 milliseconds.

Typical schedulers use priority to choose between tasks to perform. For example, since a first task has a priority of 4, and a second task has a priority of 3, the first task will be scheduled before the second task. However, the inclusion of additional information allows the software scheduler to make more intelligent choices.

Looking at the information provided above, it can be seen that the second task can be completed in 0.1 seconds, which is less than the latest start time of 0.3 seconds, indicated by the first task. In other words, the second task can be performed prior to the first task, and both will satisfy their timing requirements. However, if the first task is performed first, it completes in 0.5 seconds, which is greater than the latest start time of 0.2 seconds, indicated by the second task. Therefore, if the first task is completed first, the second task must fail.

Thus, in one embodiment, the scheduler obtains, for a first task, the earliest start time 320 and the latest start time 340. This latest start time 340 of the first task is then compared to the task duration 330 of a second task. If the second task can be completed before the latest start time 340 of the first task, the second task is scheduled prior to the first task. In certain embodiments, this scheduling decision is made regardless of the comparative priorities of the two task. In other words, even though the first task has a higher priority than the second task, the second task is scheduled first.

Stated differently, if (present time + task duration 330 of second task) is less than (latest start time 340 of first task), then the second task may be scheduled before the first task. Note that this comparison only needs to be made if the priority of the second task is less than or equal to the priority of the first task. This is because, by default, higher priority tasks are scheduled before lower priority tasks.

Note that this example only shows two pending tasks. In certain embodiments, the software scheduler 200 may have three or more pending tasks that it must select between. Further, once the software scheduler 200 selects the second task in the example above, the Zigbee network software stack 110 will present a new task to the software scheduler 200, which must be categorized and prioritized by the software scheduler 200. This is time and processing power intensive.

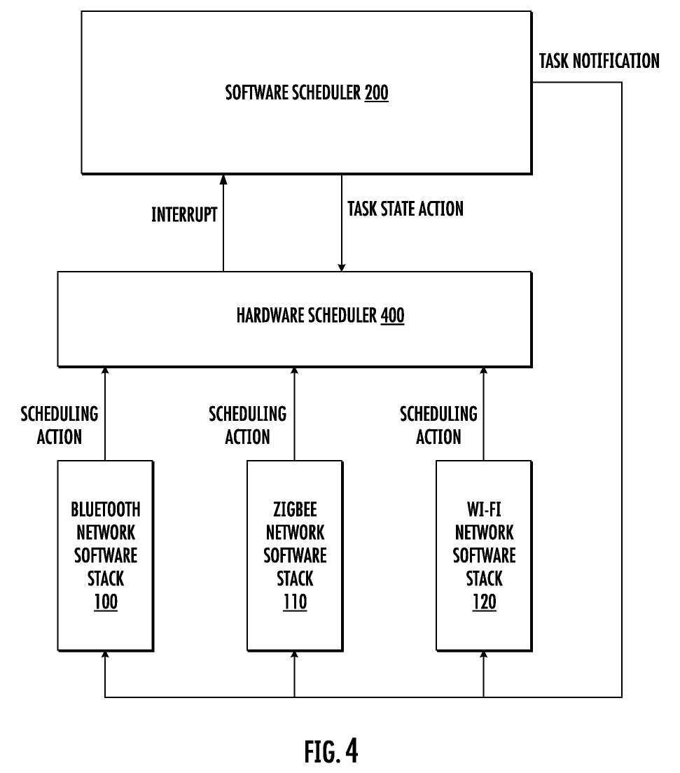

To address this, a hardware scheduler 400 is used in conjunction with the software scheduler 200. The hardware scheduler 400 contains electronic circuits and logic to implement the functions described herein. FIG. 4 shows the interconnection between the network protocol software stacks, the hardware scheduler 400 and the software scheduler 200. Each of the network protocol software stacks include a queue of tasks, which may be transmit requests, receive requests and others. The tasks at the head of the respective queue is shared with the hardware scheduler 400. The network protocol software stacks provide information to the hardware scheduler 400, in the form of scheduling actions. These scheduling actions may include actions such as Add Task, Remove Task or Update Task. Note that there is no communication from the hardware scheduler 400 to the network protocol software stacks in this embodiment.

The interface between the software scheduler 200 and the network protocol software stacks represent task notifications. These task notifications may include notifications such as Task Started, or Task Failed. These notifications inform the respective network protocol software stack of the status of the tasks that was previously at the head of its queue. Note that the network protocol software stacks do not transmit any information directly to the software scheduler 200 in this embodiment.

The communication between the hardware scheduler 400 and the software scheduler 200 is bidirectional. The hardware scheduler 400 provides interrupts to the software scheduler 200 whenever a task is to start. The software scheduler 200 informs the hardware scheduler 400 of task state actions. These task state actions may include Activate Task, Pend Task or Remove Task.

In one embodiment, each network protocol software stack may have one or more active queues. One queue may be dedicated to transmissions, while the second queue is dedicated to receiving packets. In some cases, the second queue may be populated with one task, referred to as a background task, since it is always available to execute. Specifically, whenever the Wi-Fi network software stack 120 is not transmitting a packet, it may wish monitor the wireless medium for incoming packets. When a packet needs to be transmitted, the receive task is pre-empted and the transmission task takes place. After the transmission is completed, the receive task is again executed.

Thus, in some embodiments, there may be 1 or 2 queues associated with each network protocol. In some embodiments, two network protocols that share similar network configuration settings may share a receive queue.

The hardware scheduler 400 comprises one state machine for each queue. Thus, if there are three different network protocols, there may be between 3 and 6 queues and therefore, between 3 and 6 state machines. Each state machine processes the task that is at the head of its respective queue.

Each state machine comprises a plurality of registers that allow the associated network protocol software stack to provide relevant information, such as earliest start time, latest start time, task priority, initialization time and task duration, to the state machine. This information is referred to as task metadata. Based on the task metadata, each state machine determines when to provide an interrupt to the software scheduler 200. Each state machine also has the ability to defer a task, and provide another interrupt if necessary.

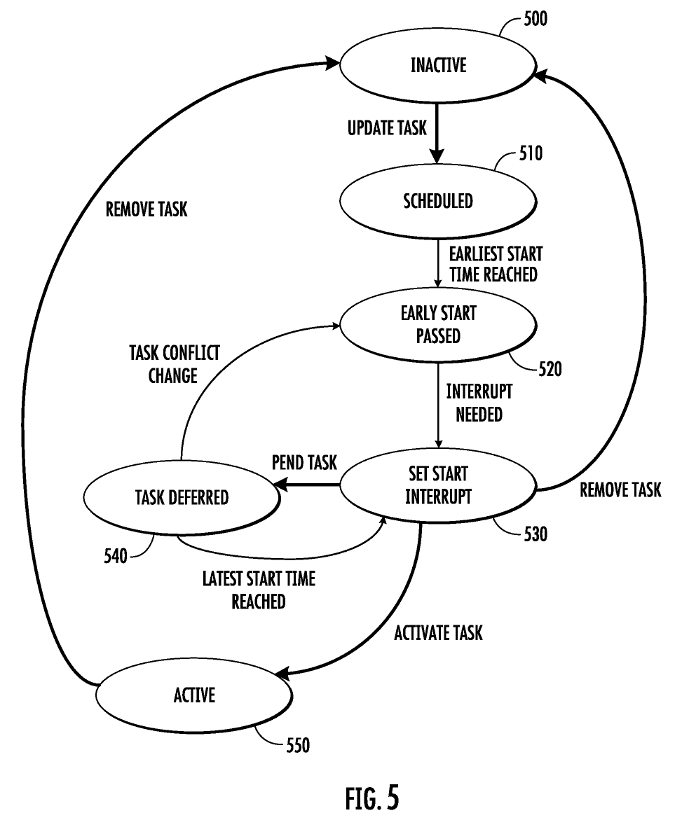

FIG. 5 shows a flowchart showing the operation of a state machine contained within the hardware scheduler 400. Note that, in some embodiments, there may be a plurality of identical state machines, one for each queue.

As shown in Box 500, the default state of the state machine is the INACTIVE state. This state indicates that there is currently no task associated with this state machine. This state is reached from any state if the current task is removed from the state machine by the associated network protocol software stack or the software scheduler 200. This may be done by providing a command of “REMOVE TASK” to the state machine. The state machine remains in this state until a task is provided to it by the associated network protocol software stack. This may be done by the associated network protocol software stack by writing to the registers in the state machine that store the task metadata. Further, there may be a separate bit, such as in a command register, writable by the associated network protocol software stack, that indicates that a new task is available. This is referred to as “UPDATE TASK” in FIG. 5. Note that the bold lines in FIG. 5 indicate transitions that are initiated by some software communication with the hardware scheduler 400. Other transitions are managed internally by the state machine. Once the task has been updated, then state machine transitions to a state referred to as the SCHEDULED state, as shown in Box 510. In this state, the state machine compares the current time (which may be obtained from timer 50) to the adjusted earliest start time of the task. In some embodiment, the adjusted earliest start time is equal to the earliest start time received from the network protocol software stack. In some embodiments, the state machine may deduct the initialization time from the earliest start time received from the network protocol software stack to determine the adjusted earliest start time before making the comparison. If the current time is equal to or greater than the adjusted earliest start time, the state machine transitions to the EARLY START PASSED state, as shown in Box 520. Once in this state, the state machine determines whether the present conditions are such that an interrupt should be generated. For example, if there is no task currently running, as indicated by a variable that is maintained by the hardware scheduler 400, the state machine will immediately transition to the SET START INTERRUPT state, as shown in Box 530. Additionally, if the current task is a background task, and the task associated with the state machine has a higher priority than this background task, the state machine will transition to the SET START INTERRUPT state. Finally, if the current time is equal to or greater than the adjusted latest start time of the task associated with this state machine, the state machine will transition to the SET START INTERRUPT state. In some embodiments, the adjusted latest start time is equal to the latest start time received from the network protocol software stack. In some embodiments, the state machine may deduct the initialization time from the latest start time received from the network protocol software stack to determine the adjusted latest start time before making the comparison. Stated differently, the state machine will generate an interrupt if:
The radio of the network device is idle;
The radio of the network device is executing a background task having a lower priority; or
The adjusted latest start time is reached.

Once the state machine generates an interrupt, it waits for a response from the software scheduler 200 or its network protocol software stack. Note that each state machine is able to generate an interrupt. In certain embodiments, the software scheduler 200 accesses a status register which indicates which state machines generated interrupts. Based on this, the software scheduler 200 is able to determine which task or tasks are ready to be executed.

In certain situations, the software scheduler 200 will activate the task from this state machine and inform the state machine of this action by issuing an “ACTIVATE TASK” command. In this situation, the state machine transitions to the ACTIVE state, as shown in Box 550. The hardware scheduler 400 also stores the fact that there is a currently executing task and the identity of that task. The software scheduler 200 also informs the associated network protocol software stack of its decision and allows that network protocol software stack to execute the task. In other situations, the software scheduler 200 may defer execution of this task and provide an indication of this action to the state machine, referred to as the “PEND TASK” command. In this situation, the state machine transitions to the TASK DEFERRED state, as shown in Box 540. Finally, in some situations, the software scheduler 200 may determine that this task cannot be executed in the prescribed timeframe and communicate this to the network protocol software stack. In response, the network protocol software stack may communicate this to the state machine via a REMOVE TASK command. Alternatively, the software scheduler 200 may directly issue the REMOVE TASK to the hardware scheduler 400. In each situation, the hardware scheduler 400 may return to the INACTIVE state, as shown in Box 500.

If the state machine transitions to the ACTIVE state, as shown in Box 550, the state machine remains in this state until it is informed that the task is to be removed via a REMOVE TASK command. This indication may be provided by the software scheduler 200 or the associated network protocol software stack. Once it receives this indication, the state machine returns to the INACTIVE state, as shown in Box 500.

If the state machine transitions to the TASK DEFERRED state, as shown in Box 540, it remains in this state until one of two conditions occurs. If the current time is greater than the adjusted latest start time of the task, the state machine transitions back to the SET START INTERRUPT state, as shown in Box 530. Alternatively, if the task conflict changes, the state machine transitions to the EARLY START PASSED state, as shown in Box 520. Specifically, each task may have an associated conflict table. This conflict table is used to indicate whether its slotted timeframe overlaps with any other task. In some embodiments, the hardware scheduler 400 compares the task metadata for each task that is loaded into the state machines and creates the conflict table for each task. For example, assume a first task has an earliest start time of 0 milliseconds and a duration of 200 milliseconds, and a second task has an earliest start time of 100 milliseconds and a duration of 500 milliseconds. Thus, a conflict exists during the time period from 100 milliseconds to 200 milliseconds. Consequently, both tasks will indicate a conflict exists. Further, the conflict table may also indicate which tasks this task has a conflict with. When either the first task or the second task is removed from its respective state machine, the conflict table for the other task will be updated. This causes the transition back to the EARLY START PASSED state. The state machine then reviews the criteria to transition to the SET START INTERRUPT state to determine if and when an interrupt should be generated.

In some embodiments, the state machine may be responsible for ensuring that two tasks are not executing at the same time. Thus, in certain embodiments, when in the SET START INTERRUPT state and the task is activated, the state machine may verify that there is no currently executing task. If there is, the state machine may generate an error interrupt.

In operation, each network protocol software stack manages its own queue or queues. The network protocol software stack may use any desired scheme to prioritize its tasks in the queues. Each network protocol software stack then provides the task at the head of its queue or queues to an associated state machine. This involves loading various task metadata, such as earliest start time, latest start time, task priority, initialization time and others. After these parameters are provided to registers in the associated state machine, the network protocol software stack then issues an “UPDATE TASK” command to the associated state machine. This may be performed by writing a specific value to a command register, although other mechanisms may also be used. Once this command is issued, the state machine moves from the INACTIVE state to the SCHEDULED state. The state machine remains in this state until the adjusted earliest start time is reached. This marks the earliest time that the task may be initiated by the software scheduler 200. Once the current time is equal to or greater than the adjusted earliest start time, the state machine transitions to the EARLY START PASSED state. The state machine remains in this state until one of the conditions described above is reached, at which time, it generates an interrupt.

This interrupt is serviced by the software scheduler 200. In processing this interrupt, the software scheduler 200 may determine, based on various criteria, that the task should be started. Specifically, the software scheduler 200 checks this task’s conflict table to understand if this task has a conflict, and if so, with which task or tasks. The software scheduler 200 may then analyze the tasks identified in this task’s conflict table to evaluate whether the task should be started. In some cases, there are no conflicts or this task is deemed to be the most important. In this case, the software scheduler 200 informs this state machine that its task has been initiated by writing an “ACTIVATE TASK” command to the state machine. This causes the state machine to transition to the ACTIVE state, where it remains until the task is removed. Another straightforward scenario is the case where the software scheduler 200 determines that there are more important tasks to execute and it will not be able to execute this task within the prescribed time frame. In this scenario, the software scheduler 200 may inform the network protocol software stack that this task will not be executed. In response, the network protocol software stack may issue a “REMOVE TASK” command to the state machine. Alternatively, the software scheduler 200 may issue the “REMOVE TASK” command directly to the hardware scheduler 400. In either embodiment, the state machine transitions to the INACTIVE state. A more complicated scenario is when the software scheduler 200, after reviewing the various conflict tables and task metadata, chooses to start a different task and retains the option to start this task at a later time (which is before its latest start time). In this case, the software scheduler 200 may issue a “PEND TASK” command to the state machine, which causes the state machine to transition to the TASK DEFERRED state. From this state, the state machine may transition directly to the SET START INTERRUPT state if the latest start time is reached. Alternatively, the state machine may transition to the EARLY START PASSED state if there is a change in the task’s conflict table, as described above.

Note that this state machine may be modified in the case of background tasks. For example, in certain embodiments, the background task will not be removed, so there is no need to include the transitions from the SET START INTERRUPT state to the INACTIVE state. Further, since this a background task has a low priority, there may also be a transition from the ACTIVE state to the TASK DEFERRED state, which is caused by transmission of a “PEND TASK” command from the software scheduler 200. Thus, unless this background task is removed by the network protocol software stack, the state machine will transition between the ACTIVE state and the TASK DEFERRED state over the course of its lifetime.

This scheduler has many advantages. Previously, when a task was selected and a new task was introduced to the software scheduler, the software scheduler had to insert the new task into a sorted list of pending tasks. This introduced significant time delays and consumed valuable processing time. By adding a hardware scheduler 400, the task that has the smallest earliest start time is automatically identified by the generation of an interrupt.

Additionally, without a hardware scheduler, the software scheduler is required to maintain a linked list representing the task queue. Currently, there are times during both scheduling actions and during the timer interrupt when the software scheduler must decide whether to start/pend/remove a particular task. This requires the software scheduler to iterate through some or all of the linked list queue. This iteration may occur multiple times during a given decision point. The use of a hardware scheduler decreases the timing overhead incurred by the software scheduler.

Finally, the generation of the interrupt is now performed in hardware, further reducing the complexity and decision logic required of the software scheduler.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A network device, comprising:
a network interface that comprises a radio;
a processing unit;
a hardware scheduler; and
a memory device, in communication with the processing unit, wherein the memory device comprises:
a plurality of network protocol software stacks, each responsible for managing a network protocol; and
a software scheduler;
wherein each network protocol software stack provides metadata about a task to the hardware scheduler;
wherein the hardware scheduler uses the metadata to determine when to generate an interrupt to the software scheduler; and
wherein, after receiving the interrupt, the software scheduler:
selects one of the tasks; and
schedules the selected task to be executed by the network interface.

2. The network device of claim 1, wherein the metadata comprises:
an earliest start time, which is an earliest time that the task can begin;
a latest start time, which is a latest time that the task can begin; and
a priority.

3. The network device of claim 2, wherein the metadata comprises an initialization time, which is a time required for the software scheduler to configure the network interface to perform the task.

4. The network device of claim 1, wherein if a current time is greater than an adjusted earliest start time of the task, the hardware scheduler generates the interrupt if:
the network interface is idle;
the network interface is executing a background task having a lower priority; or
the current time is greater than an adjusted latest start time of the task.

5. The network device of claim 1, wherein each network protocol software stack comprises a queue of tasks associated with the network protocol, and wherein the metadata is associated with the task at a head of the queue of tasks.

6. The network device of claim 1, wherein the hardware scheduler comprises a plurality of state machines, each state machine associated with one of the plurality of network protocol software stacks, wherein each state machine is provided with the metadata.

7. The network device of claim 6, wherein each of the plurality of state machines determines when to generate the interrupt based on the metadata.

8. The network device of claim 1, wherein, after receiving the interrupt, the software scheduler defers a task, and wherein the hardware scheduler generates a second interrupt when a current time exceeds a latest adjusted start time for the deferred task.

9. The network device of claim 1, wherein, after selecting the task, the software scheduler cancels another task, and wherein the hardware scheduler returns to an inactive state awaiting new task metadata from a network protocol software stack associated with the cancelled task.

10. The network device of claim 1, wherein after the task is executed and completed, the network protocol software stack associated with the completed task provides metadata about a second task to the hardware scheduler.

11. The network device of claim 1, wherein each task has an associated conflict table and the software scheduler evaluates the conflict table before selecting the task to execute.

12. A method of scheduling tasks in a network device that supports multiple network protocols, comprising:
providing a network protocol software stack for each network protocol, wherein each network protocol software stack comprises a queue of tasks to be executed by a network interface of the network device;
copying, from each network protocol software stack to a hardware scheduler, metadata from one task of its respective queue of tasks;
using the hardware scheduler to determine when to generate an interrupt for each task to a software scheduler; and
upon receiving the interrupt from the hardware scheduler, using the software scheduler to select a task to execute and inform the network protocol software stack of the selection.

13. The method of claim 12, wherein, in response to receiving the interrupt, the software scheduler may select to execute, defer or cancel the task.

14. The method of claim 12, wherein the metadata comprises:
an earliest start time, which is an earliest time that the task can begin;
a latest start time, which is a latest time that the task can begin; and
a priority.

15. The method of claim 14, wherein the metadata comprises an initialization time, which is a time required for the software scheduler to configure the network interface to perform the task.

16. The method of claim 12, wherein if a current time is greater than an adjusted earliest start time of the task, the hardware scheduler generates the interrupt if:
the network interface is idle;
the network interface is executing a background task having a lower priority; or
the current time is greater than an adjusted latest start time of the task.

17. The method of claim 12, wherein, after receiving the interrupt, the software scheduler defers a task, and wherein the hardware scheduler generates a second interrupt when a current time exceeds a latest adjusted start time for the deferred task.

18. The method of claim 12, wherein, after selecting the task, the software scheduler cancels another task, and wherein the hardware scheduler returns to an inactive state awaiting new task metadata from a network protocol software stack associated with the cancelled task.

19. The method of claim 12, wherein after the task is executed and completed, the network protocol software stack associated with the completed task provides metadata about a second task to the hardware scheduler.

20. The method of claim 12, wherein each task has an associated conflict table and the software scheduler evaluates the conflict table before selecting the task to execute.
